(19) United States
(12) Patent Application Publication
(10) Pub. No.: US 2005/0259820 A1
(43) Pub. Date: Nov. 24, 2005

(54) Temporally distributed watermarking for image sequences

(75) Inventor: Paul W. Jones, Churchville, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/852,616

(22) Filed: May 24, 2004

(51) Int. Cl. G06K 9/00

(52) U.S. Cl. 380/201

(57) ABSTRACT

A method for temporally distributing a watermark signal into a sequence comprising a plurality of original image frames is disclosed. The watermark signal represents an N-bit codeword, where N is greater than or equal to two. For each original image frame in the sequence, a subset of bits is selected from the N-bit codeword and a watermark pattern generated according to the subset of bits. The watermark pattern is combined with the original image frame to produce a watermarked image frame. Over the sequence of original image frames, all bits in the N-bit codeword are selected in at least one of the subsets of bits.

### FIELD OF THE INVENTION

The invention relates generally to the field of digital image processing, and in particular to a method for embedding watermarks in digital image sequences.

### BACKGROUND OF THE INVENTION

Digital watermarking refers to the embedding of a hidden message in an image or image sequence for such purposes as establishing ownership, tracking the origin of the data, preventing unauthorized copying, or conveying additional information (meta-data) about the content. Watermarking has potential uses in a wide range of products, including digital still and video cameras, printers and other hardcopy output devices, and content delivery services (e.g., Internet-based photofinishing). Recently, there has been significant interest in the electronic distribution and display of theatrical movies, termed digital cinema. Studios and distributors have a compelling need to protect movie content from unauthorized use, and watermarking can assist by establishing ownership and identifying the source of stolen content (for example, through the use of hidden date/time/location stamps inserted at the time of the movie distribution and/or presentation). Likewise, watermarking can be used for traditional film-based motion picture systems, where a watermark is exposed on the motion picture film during film manufacture or during the printing of the final image content. Watermarking of image sequences has a number of useful applications with both digital cinema and traditional motion picture systems.

Numerous watermarking methods have been described in prior art, patents and technical literature. Among these are methods described in review papers such as: Hartung and Kutter, “Multimedia Watermarking Techniques”, Proc. IEEE, 87(7), pp. 1079-1107 (1999), and Wolfgang et al., “Perceptual Watermarks for Digital Images and Video”, Proc. IEEE, 87(7), pp. 1108-1126 (1999). Many watermarking techniques make use of a pseudo-random number (PN) sequence in the watermark generation and extraction processes. The PN sequence serves as a carrier signal, which is modulated by the original message data, resulting in dispersed message data (that is, the watermark) that is distributed across a number of pixels in the image. A secret key (termed a “seed value”) is commonly used in generating the PN sequence, and knowledge of this key is required to extract the watermark and the associated original message data.

As noted in the Hartung et al. and Wolfgang et al. review papers, most research on watermarking techniques has focused on single-frame images. There are significantly fewer methods that are specific to multi-frame image sequences (that is, video watermarking). Of course, the same watermarking method that has been designed for single-frame images could be applied to an image sequence by merely repeating the same watermarking process for each frame. However, this approach has a significant disadvantage: a repeated, fixed watermark pattern may become perceptually objectionable when the image frame sequence is displayed in real-time. An encoded pattern that might not be easily visible within the single image of a print could become visible and annoying if it appears in a sequence of image frames. Thus, watermarking techniques for still images and prints may not be well suited to motion picture film media. Moreover, a motion picture watermark must be detectable from a copy, such as a videotape copy, that is captured in a timing sequence that typically varies from the timing of motion picture frames through projection equipment and with varying image resolution, lighting, and filtering. For these and related reasons, motion picture watermarking requires a special set of techniques beyond those normally applied for still images.

In response to this problem are several prior art patents that address video-specific watermarking methods, including: U.S. Pat. No. 5,809,139 issued Sep. 15, 1998 to Girod et al. entitled “Watermarking Method and Apparatus for Compressed Digital Video”; U.S. Pat. No. 5,901,178 issued May 4, 1999 to Lee et al. entitled “Post-Compression Hidden Data Transport for Video”; and U.S. Pat. No. 5,991,426 issued Nov. 23, 1999 to Cox et al. entitled “Field-Based Watermark Insertion and Detection”.

Methods of the '139 Girod et al. and '178 Lee et al. patents are designed for directly embedding a watermark in compressed frequency-domain video streams (such as MPEG-encoded sequences). However, these methods are not applicable to the watermarking of motion picture film, because these methods operate directly on a compressed video stream, and such a compressed video stream is never generated when a watermark is exposed onto film. The '426 Cox et al. patent discloses a method for alternately embedding positive and negative watermarks in consecutive fields of an interlaced video signal; however, this method is not suitable for progressively scanned image sequences such as those used in digital cinema applications or with the individual frames of a motion picture film.

U.S. Pat. No. 6,026,193 issued Feb. 15, 2000 to Rhoads, entitled “Video Steganography”, discloses the basic concept of using multiple watermarked frames from an image sequence to extract the watermark with a higher degree of confidence than would be obtained with only a single frame. U.S. Pat. No. 6,449,379 to Rhoads entitled “Video steganography methods avoiding introduction of fixed pattern noise” proposes an improvement to this scheme by changing the PN carrier from frame to frame, for example. However, with such an approach, the management of numerous carriers (and their associated keys) becomes complex. Extraction of a watermark in a scheme employing many different carriers can also require significant computational effort, in part because it becomes necessary to determine which carrier was used for a given frame. This requires either an exhaustive search of all possible carriers, or temporal synchronization of successive image frames in some manner, so that the carrier for each frame is known. Another modification is to change the encoded message while using the same carrier signal; however, it may not be desirable to change the message from frame to frame in many applications. Moreover, changing the message from frame to frame does not allow information from multiple frames to be combined when extracting the watermark.

Another approach to applying a watermark without the disadvantages of a fixed watermark pattern is to use a three-dimensional watermark pattern. An example of such a method can be found in a paper by J. Lubin et al, “Robust, content-dependent, high-fidelity watermark for tracking in digital cinema,” in Security and Watermarking of Multimedia Contents V, Proc. SPIE, Vol. 5020, Jan. 24, 2003. This paper discusses a method for embedding, into successive image frames, a watermark containing low frequency content in both the spatial and temporal dimensions. The method described by Lubin et al. may provide a temporally distributed watermark that is relatively robust. However, this method suffers from a key limitation for temporally distributed watermarking schemes: the requirement for temporal synchronization in order to recover or decode the watermark. That is, some method must be provided that allows indexing of each image frame with a reference frame; a sampling of successive image frames must include this reference in order to allow synchronization of watermarked frames and subsequent decoding. Significantly, the method described by Lubin et al. requires prior knowledge of the image content before application of a watermark is possible. Thus, this method would not be suitable for use as a pre-exposure scheme by a film manufacturer.

As the disclosures of each of the patents cited above clearly show, the task of providing an unobtrusive yet robust watermarking scheme for motion pictures is considerably more complex than that of providing a watermark for photographs and other types of still images. Because motion picture imaging requires multiple frames displayed in rapid succession, any suitable watermarking scheme must take into account the time dimension, in addition to spatial considerations for application of the watermark itself. Schemes that employ complex arrangements with multiple messages and/or multiple carriers may provide watermarking patterns that are difficult for a viewer to detect and difficult to remove. However, such complex arrangements may have compromised robustness and generally require considerable management and computational resources, rendering these solutions unwieldy in many practical applications. Moreover, schemes that require some type of temporal synchronization, requiring specific indexing of the image frames or a realignment of the frames relative to an original sequence, are typically more complex for both encoding and decoding processes.

Thus, it can be seen that there would be benefits in a watermarking scheme for digital motion picture images that is unobtrusive for the viewer, obviates the need for managing multiple carriers or messages, and is robust. Moreover, there would be special advantages to a watermarking scheme that takes advantage of the temporal dimension of motion picture imaging, but that does not require temporal synchronization of successive frames in the watermarked sequence.

### SUMMARY OF THE INVENTION

It is an object of the present invention to provide an improved watermarking scheme for motion picture and related image sequences. With this object in mind, the present invention provides a method for temporally distributing a watermark signal into a sequence comprising a plurality of original image frames, wherein the watermark signal represents an N-bit codeword and wherein N is greater than or equal to two, the method comprising, for each original image frame in said sequence, the steps of:
(a) selecting a subset of bits from the N-bit codeword;
(b) generating a watermark pattern according to said subset of bits; and
(c) combining said watermark pattern with said original image frame to produce a watermarked image frame;
whereby, over said sequence comprising said plurality of original image frames, all bits in the N-bit codeword are selected in at least one of said subsets of bits.

It is an advantage of the method of the present invention that it provides a secure watermarking scheme that is substantially imperceptible to a viewer. Because the method of the present invention varies the watermarking pattern over a sequence of frames, any perceptible effect to the viewer is a “time-varying” look similar to that of film grain.

It is a further advantage of the present invention that it provides a robust watermarking scheme that can be detected from a sample of image frames and is relatively independent of the sample taken, provided that a sufficient number of frames are included in the sample.

It is yet a further advantage of the present invention that it provides a method for encoding a message that is substantially robust, effectively splitting the message “payload” over a series of image frames.

It is yet a further advantage of the present invention that it provides a time-varying watermarking scheme for motion picture imaging that does not require temporal synchronization. That is, a sample of a sufficient number of image frames can be decoded without requiring a synchronization frame of any kind.

It is yet a further advantage of the present invention that it can minimize the extraction complexity and the requirements for carrier management by allowing the use of a single watermark carrier signal.

It is yet a further advantage of the present invention that it is more robust to intentional attacks that try to detect and remove the watermark pattern.

It is yet a further advantage of the present invention that it can be combined with other more complex methods including public/private key encryption and use of multiple carriers and/or messages.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram showing basic steps for embedding a watermark into an image frame using prior art techniques;

FIG. 2a is a plane view showing the design of a message or shift template using prior art techniques;

FIG. 2b is a plane view showing how message bits can be considered as a series of (xy) prior art offsets within a message array;

FIG. 3 is a block diagram showing basic steps for extracting watermark message bits from an image watermarked using the steps of FIG. 1, using prior art techniques;

FIG. 4 is a prior art plane view showing a watermark tiling arrangement for an image frame;

FIG. 5 is a plane view representing how message array can be decomposed into a set of partial message arrays;

FIG. 6 is a block diagram showing the embedding of watermarks into a number of successive motion picture image frames according to the present invention;

FIG. 7 is a block diagram showing the procedure for extracting message bits from successive motion picture frames that have been watermarked using the procedure of FIG. 6; and

FIG. 8 is a block diagram showing an alternative embodiment for the embedding of watermarks into a number of successive motion picture image frames according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

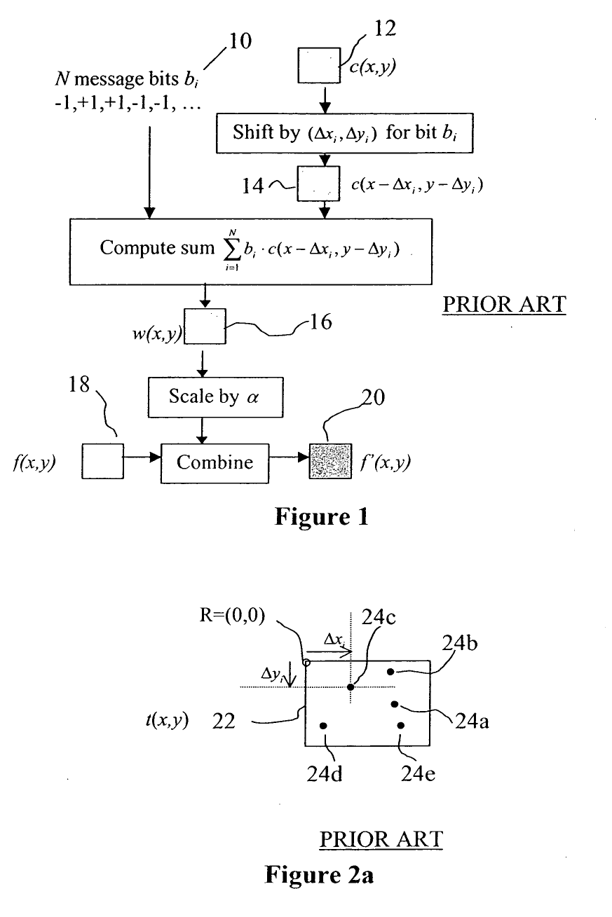

In order to describe various components that can be used in the watermarking scheme of the present invention and to differentiate the method of the present invention from other proposed approaches for motion picture frame watermarking, it is instructive to give a brief overview of a prior art method that has been proposed for applying a watermark to an image frame. This method has been disclosed in U.S. Pat. No. 6,665,418 to Honsinger, entitled “Linear Projective Data Embedding”. Referring to FIG. 1, there is shown a processing sequence for embedding a two-dimensional watermark pattern w(x,y) 16 that encodes a message payload consisting of a string of N message bits 10, bᵢ, i=1, . . . , N using a carrier signal c(x,y) 12. For convenience, the message bits are represented as either −1 or +1 (for example, a “0” bit is mapped to −1 and an “1” bit is mapped to +1), and a spatial shift (Δxᵢ,Δyᵢ), i=1, . . . , N, is associated with each bit in the N-bit message string. The watermark pattern is produced by the steps of: (1) cyclically shifting the carrier signal 12 by (Δxᵢ,Δyᵢ) to produce a shifted carrier signal c(x−Δxᵢ,y−Δyᵢ) 14 that is associated with message bit bᵢ; (2) multiplying the shifted carrier by the value of bᵢ to produce a signed, shifted carrier that is associated with message bit bᵢ; and (3) adding the signed, shifted carriers that are associated with each of the message bits to produce the final watermark pattern w(x,y) 16. This pattern is then combined with the original image f(x,y) 18 to produce the watermarked image f′(x,y) 20. The watermark pattern w(x,y) 16 can also be scaled by an overall multiplicative factor α prior to combining to provide a watermark signal amplitude that meets the desired visibility and robustness requirements. Mathematically, we can represent this watermark generation and embedding process as follows:

$${f}^{′} ( x , y ) = f ( x , y ) + α {\sum }_{i = 1}^{n} {b}_{i} \cdot c ( x - Δ {x}_{i} , y - Δ {y}_{i} ) . \qquad ( 1 )$$

The combining process that produces the watermarked image can also take other forms than that indicated in Eq. 1, for example, multiplication of the original image and the watermark instead of addition, the inclusion of an overall mean level in the watermark, signal-dependent α terms, etc.

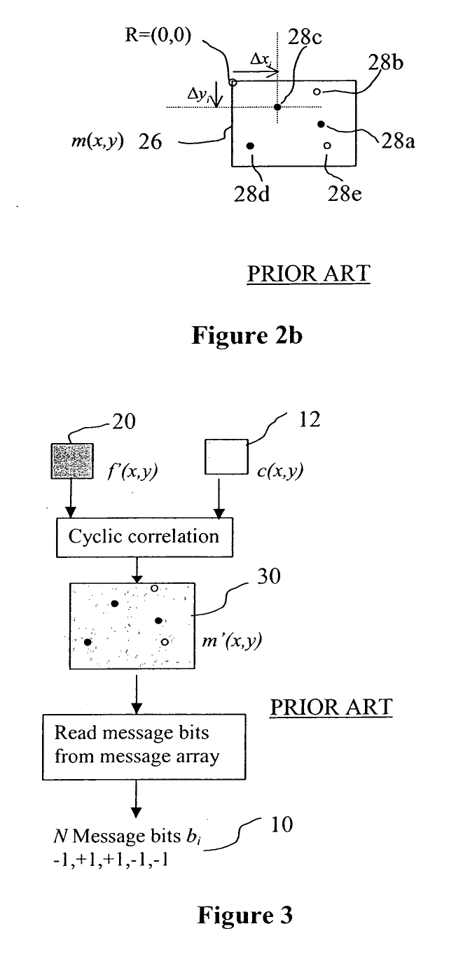

As disclosed in U.S. Pat. No. 6,665,418 to Honsinger and illustrated in FIG. 2a, the cyclical shifts (Δxᵢ,Δyᵢ), i=1, . . . , N, can be represented as a two-dimensional shift template t(x,y) 22, which is a rectangular array containing delta functions δ(x, y) at the locations (Δxᵢ,Δyᵢ), i=1, . . . , N, relative to a reference point R=(0,0). In FIG. 2a, an example set of five delta functions 24a, 24b, 24c, 24d, and 24e is represented. The specific value for each (Δxᵢ,Δyᵢ) is chosen based upon certain desired properties such as the autocorrelation of shift template 22. The choice of the reference point R is arbitrary, but for convenience, the upper left corner of shift template 22 can be designated as (0,0).

Because there is a one-to-one relationship between the message bits bᵢ, i=1, . . . , N and the shift locations (Δxᵢ,Δyᵢ),i=1, . . . , N, each message bit can be associated with a delta function in shift template 22. Correspondingly, as shown in FIG. 2b, the message bits can also be represented as a message array m(x,y) 26, where each message bit bᵢ is represented as a delta function with a value of either −1 or +1 at the location (Δxᵢ,Δyᵢ) in the message array relative to a reference point R=(0,0). An example of message array 26 is shown in FIG. 2b, where the delta functions for five message bits 28a, 28b, 28c, 28d, and 28e are illustrated. These five message bits might correspond, for example, to the message bits b₁, b₂, b₃, b₄, and b₅ in the total message payload of N bits. The associated shift locations are (Δx₁,Δy₁), (Δx₂,Δy₂), (Ax₃,Δy₃), etc. In this example, the delta functions representing message bits 28b and 28e, represented by hollowed circles, are the opposite polarity of message bits 28a, 28d, and 28e (for example, bits 28b and 28e are +1, while the other bits are −1).

Referring to FIG. 3, the recovery of the N message bits 10 from a watermarked image is performed by cyclically correlating carrier c(x,y) 12 with watermarked image f′(x,y) 20. The result is an extracted message array m′(x,y) 30, which is a corrupted version of the original message array m(x,y) 26. Mathematically, this extraction process is represented as:

$$\begin{matrix}{m}^{′} ( x , y ) = {f}^{′} ( x , y ) ⊗ c ( x , y ) \\ = f ( x , y ) ⊗ c ( x , y ) + α {\sum }_{i = 1}^{N} {b}_{i} \cdot c ( x - Δ {x}_{i} , y - Δ {y}_{i} ) ⊗ c ( x , y ) \\ = n ( x , y ) + α {\sum }_{i = 1}^{N} {b}_{i} \cdot δ ( x - Δ {x}_{i} , y - Δ {y}_{i} )\end{matrix} \qquad ( 2 )$$

where \mathring{x} represents cyclic correlation. Thus, extracted message array m′(x,y) 30 consists of delta functions representing original message bits bᵢ, i=1, . . . , N at locations (Δxᵢ,Δyᵢ), i=1, . . . , N, (and the bits are possibly scaled by α ) and also a noise term n(x,y) that is produced by the correlation of carrier c(x,y) 12 and original image f(x,y) 18. Because shift template 22 (the message template) is known beforehand, it is possible to read extracted message array m′(x,y) 30 at the proper shift locations to determine the message bit values bᵢ and thus recover the embedded message information.

A significant advantage of the watermarking process that uses shift template t(x,y) 22 and message array m(x,y) 26 is that it only requires a single carrier c(x,y) 12 instead of multiple carriers 12 as is disclosed in U.S. Pat. No. 5,850,481 assigned to Rhoads. The use of a single carrier 12 greatly simplifies the embedding and extraction processes. Furthermore, shift template 22 provides a mechanism for automatically recovering from image cropping, without the use of a separate calibration signal as is required for the technique disclosed in U.S. Pat. No. 5,850,481.

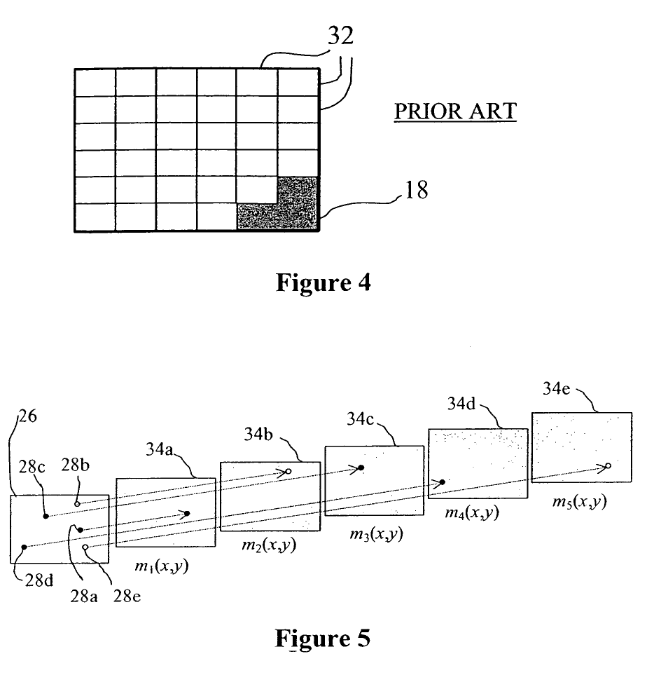

While watermark pattern w(x,y) 16 can be sized to fit the full dimensions of image frame f(x,y) 18, a tiling scheme is often more advantageous, where the watermark pattern w(x,y) 16 is repeated a number of times within the image frame. Referring to FIG. 4, there is shown an arrangement of image watermark tiles 32 overlaid onto image frame 18 (with a few image tiles 32 removed to show the underlying image frame 18). Using a tiled arrangement offers advantages for improved robustness and ease of implementation. During the extraction process, the tiles within a frame can be averaged or summed, which helps to reduce the noise term due to content, n(x,y), because the image content is typically different for each tile and hence will tend to average to zero over a large number of tiles. For the purposes of the present application, image tile 32 can be considered to occupy a full image frame f(x,y) 18, which simplifies the description of how watermark pattern 16 is applied. U.S. Pat. No. 6,044,156 to Honsinger et al., entitled “Method for Generating an Improved Carrier for Use in an Image Data Embedding Application” describes the use of the method outlined in FIG. 3 for extracting message bits 10 where the 2-D watermark pattern w(x,y) 16 has been applied to a number of sections of a single image. The same type of approach also could be applied to successive image frames in a motion picture, where the same watermark pattern 16 is used for each frame.

Given the basic watermarking embedding and extraction schemes of FIGS. 1 and 3 respectively, a number of variations have been proposed for providing a time-varying 2-D watermark pattern 16 to reduce visibility of the watermark when a sequence of frames is displayed. For example, U.S. Pat. No. 6,449,379 to Rhoads, cited earlier, discloses varying either the message bits 10 or carrier signal 12, or both, for different frames in the sequence. However, as noted previously, the extraction of a watermark in a scheme employing many different carriers 12 can require significant computational effort, because it requires either an exhaustive search of all possible carriers 12, or temporal synchronization of successive image frames in some manner, so that the carrier 12 for each frame is known. Likewise, it may not be desirable to change the message from frame to frame in many applications, and changing the message from frame to frame does not allow information from multiple frames to be combined when extracting the watermark.

Temporally Distributed Watermark Embedding and Extraction

The present invention overcomes the limitations of the prior art methods by taking an altogether different approach to the problem of providing a time-varying watermark pattern, without resorting to multiple carriers 12 or changing message bits 28. The present invention uses the concept of the message array m(x,y) 26 of FIG. 2b, but message bits 28 are temporally distributed over more than one frame of the image sequence. Importantly, both the message bits bᵢ, i=1, . . . , N comprising the total message payload and carrier signal c(x,y) 12 remain the same, but the temporal distribution of message bits 28 provides a time-varying watermark pattern. The process of embedding message bits 28 can be viewed as decomposing the original message array m(x,y) 26 into a sequence of partial message arrays mₖ (x,y), k=1,2,3, . . . , M, which distributes message bits 28 over the time dimension, and the process of extracting message bits 28 can be done by summing multiple frames, which collapses the temporally distributed message bits back into their original configuration in message array 26. Advantageously, there is no need for any type of temporal synchronization to extract the watermark with the present invention.

The temporal distribution of the message bits is illustrated by way of example in FIG. 5, where the message array m(x,y) 26 is temporally distributed over a set of five partial message arrays (M=5) 34a, 34b, 34c, 34d, and 34e. Message bit b₁28a is assigned to partial message array m₁ (x,y) 34a, message bit b₂ 28b is assigned to partial message array m₂ (x,y) 34b, and so on. Although the example in FIG. 5 shows a process for assigning only one message bit 28 to each partial message array 34, it is entirely possible to assign more than one message bit 28 to each partial message array 34; moreover, it is not even necessary to assign the same number of message bits 28 to each partial message array 34. For example, three partial message arrays (M=3) 34 could be created by assigning bits b₁ and b₂ to partial message array m₁ (x,y), bits b₃ and b₄ to partial message array m₂ (x,y), and bit b₅ to partial message array m₃ (x,y).

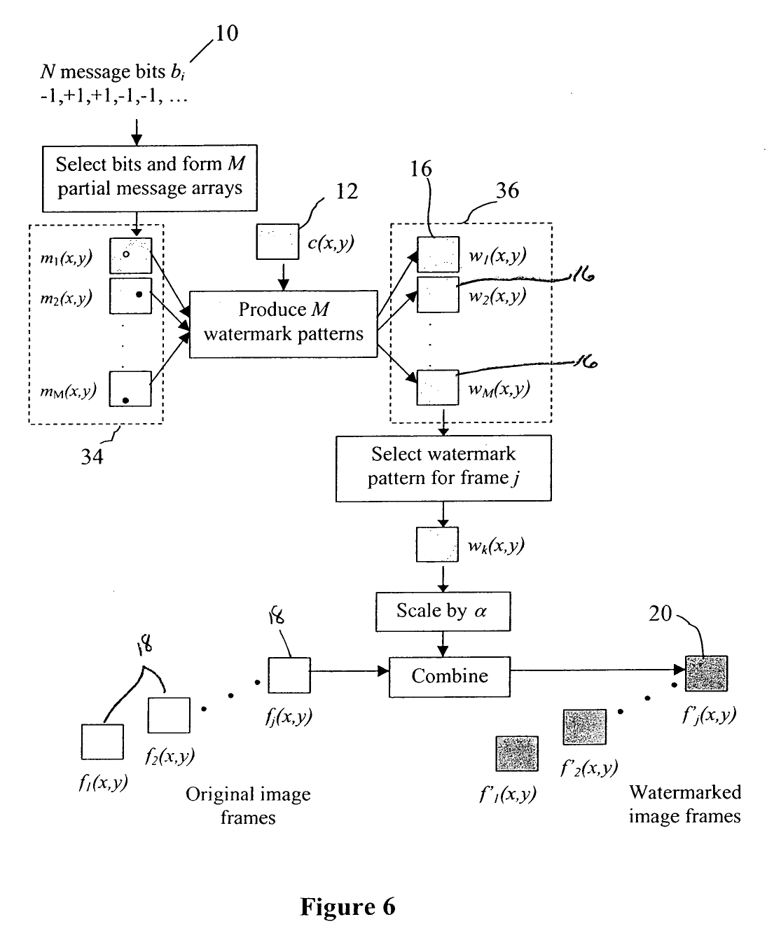

Given a set of partial message arrays 34, the generation of the watermark patterns for the image sequence frames then proceeds as illustrated in FIG. 1. For each message bit bᵢ 28 assigned to a given partial message array mₖ (x,y) 34, carrier signal 12 is cyclically shifted to (Δxᵢ,Δyᵢ) to produce shifted carrier signal 14; shifted carrier signal 14 is multiplied by the value of bᵢ to produce a signed, shifted carrier; and the signed, shifted carriers associated with the given partial message array mₖ (x,y) 34 are summed to create a final watermark pattern wₖ (x,y) 16. This process is repeated for each partial message array 34 to produce a set of watermark patterns 36 wₖ (x,y), k=1,2,3, . . . , M as shown in FIG. 6. Each watermark pattern is produced from the sum of different shifted versions of the carrier signal. Hence, each pattern has a somewhat unique appearance.

Again referring to FIG. 6, we must now select a watermark pattern from the set 36 wₖ (x,y), k=1,2,3, . . . , M for each frame in the original image sequence 18 fⱼ (x,y), j=1,2,3, . . . . The selection of the watermark patterns can be done sequentially so that watermark pattern 16 w₁ (x,y) is selected for frame f₁ (x,y), watermark pattern 16 w₂ (x,y) is selected for frame f₂ (x,y), and so on. Once the last watermark pattern 16 wₘ (x,y) has been selected for frame fₘ (x,y), the selection process repeats, starting with watermark pattern 16 w₁ (x,y). Alternately, the watermark patterns can be selected randomly for the frames in the image sequence. Each frame in the original image sequence 18 fⱼ (x,y), j =1,2,3 . . . is then combined with its selected watermark pattern (which is potentially scaled by a variable parameter α) to produce the watermarked image sequence 20 f′ⱼ(x,y), j=1,2,3, . . . . The end result is a watermark pattern that is time-varying when the image sequence is displayed.

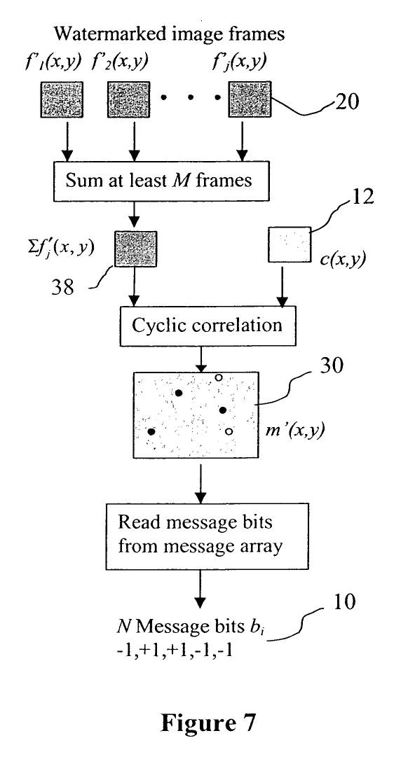

Because of the use of the message array with shifted versions of a single carrier, the extraction process is quite simple and does not require temporal synchronization. As illustrated in FIG. 7, a sufficient number of watermarked frames 20 can be simply summed to ensure that all bit positions are represented at least once in the set of frames. Subsequent decoding of the summed image frames 38 proceeds exactly as described in FIG. 3. For example, if there are N message bits 28 in total, and message bits 28 are distributed such that there is one unique message bit 28 in each frame, we would need to sum at least M=N frames to recover all N message bits 28. However, if we placed two unique message bits 28 in each frame, we would need to sum at least M=N/2 frames to recover all N message bits. Conveniently, the present invention can start the extraction process at any point in the image sequence and without regard to which watermark pattern was selected for a given frame. Although the extraction process is shown in FIG. 7 as using consecutive frames in the image sequence, this is not strictly necessary in the present invention, as will be discussed shortly.

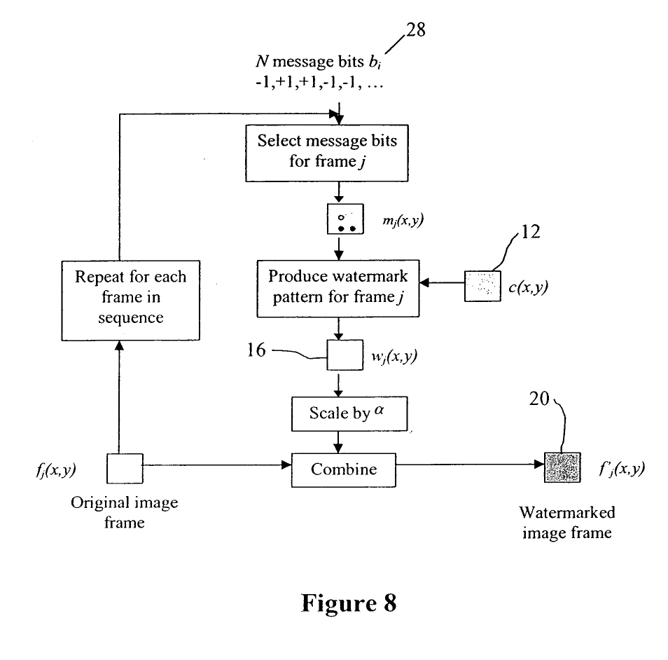

From another viewpoint, it is convenient to consider temporally distributed watermark embedding as a process of selecting those message bits 28 to be assigned to each frame in the image sequence. As shown in FIG. 8, given the selection of the specific message bits 28 for a frame, the watermark pattern generation and embedding process proceeds as discussed previously. The distinction between the embedding approaches of FIG. 6 and FIG. 8 is that FIG. 6 generates all possible watermark patterns 16 in advance, whereas FIG. 8 generates watermark patterns 16 as needed for the different frames. Of course, various combinations of these two strategies are possible, and the choice may be driven by system design issues. At a fundamental level, both approaches can be viewed as a process of assigning message bits 28 to frames in the image sequence. Because there is no need for temporal synchronization, we have almost unlimited freedom in how message bits bᵢ, i=1, . . . , N 28 are assigned to the frames.

As discussed previously, message bits 28 can be assigned to frames in a sequential manner over the temporal dimension, or bits 28 can be assigned randomly to the frames in the image sequence. In practice, it is best to assign a minimum of one message bit 28 to each frame; however, it would be possible to skip one or more frames between watermarked frames, thereby providing the watermark to a distributed sampling of non-consecutive frames. In general, the maximum number of message bits 28 assigned to each frame is typically N-1 for a total message payload of N bits. However, it is also possible to assign all N bits to a given frame as long as other temporally adjacent frames in the sequence are assigned fewer than N bits to ensure a time-varying appearance to the watermark pattern.

It must be noted that the terms “set” and “subset” as used in this application follow conventional mathematical set terminology. For a set having N elements, a non-empty subset can be any grouping of from 1 to N members. That is, a non-empty subset can be the full set of N bits or can be a non-empty proper subset of from 1 to (N-1) bits. Using the method of the present invention, any non-empty subset of the N message bits 28 can be assigned to a frame.

Moreover, an unequal number of bits can be assigned to successive image frames, as long as it is ensured that the amplitude distribution of the watermark for each frame is adjusted to be approximately the same. The amplitude adjustment of the watermark can be controlled by the variable parameter α. This adjustment is necessary because the watermark patterns are produced by summing shifted versions of the carrier signal c(x,y) 12. As more message bits 28 are assigned to a given frame, the maximum amplitude of the watermark pattern increases because more shifted versions of carrier signal 12 are summed. Adjusting a for each frame helps provide a visually equivalent watermark amplitude distribution from frame to frame, while still yielding a time-varying watermark.

A primary goal of the present invention is to provide a time-varying watermark pattern for reduced visibility. The temporal distribution of the message bits within the present invention can be varied based on a tradeoff between visibility and extraction performance. For example, it may be desirable to have the watermark pattern change as much as possible from frame to frame. One way to achieve this is to assign only one message bit of the N possible bits to each frame, which insures that the watermark pattern will be completely different for each frame within an N-frame interval. This is the scheme represented in FIG. 5. The tradeoff with such a strategy is that it requires a minimum of N frames to recover the entire message payload of N message bits 28. An alternative might be to assign N/2 message bits to each frame, which potentially allows the entire message payload to be recovered in only two frames. The downside is that the watermark pattern will repeat every other frame, which may introduce a temporal distortion effect that is analogous to flicker.

Other selections can be made for the message bit assignments that provide a balance between visual differences in the watermark pattern from frame to frame, that optimize temporal repetition rate of the patterns, and that provide a minimum number of frames required to extract the entire message payload. Indeed, it is possible to compute, a priori, certain groupings of message bits 28 that maximize the visual differences of the watermark patterns in consecutive frames. The pattern differences can be quantified using simple metrics, such as the mean-squared error (MSE) between frames. More sophisticated metrics are also available to those skilled in the imaging arts using human visual system models that assess the perceptibility of frame differences under specific viewing conditions. These groupings may or may not have equal numbers of message bits 28 as described previously. It may also be desirable to repeat the same watermark pattern (i.e., the same bit assignment) for two or more consecutive frames 18. This increases the probability of a strong extraction signal, at possible risk of increased visibility.

It may be further advantageous to provide more emphasis for certain message bits within the present invention. For example, some message bits may refer to a critical piece of information in the context of the overall system (e.g., an equipment or theater ID), while other message bits are less important (e.g., a date or time stamp). It is possible to assign the more important bits to more frames than are used for the less important bits. The more important bits can be intermingled with the less important bits if desired, e.g., the more important bits are assigned to every frame, while the less important bits are split into two or more subsets that are assigned to different frames. It is also possible to split the more important bits into two or more separate subsets and combine them in various ways with the subsets of less important bits.

In the preceding discussion, it has been implied that the recovery of message bits 28 from a sequence of frames is performed using a number of consecutive frames. This is an approach that is often convenient and may provide a successful extraction of the message bits in the minimum number of frames, particularly if message bits 28 have been assigned in a sequential manner to the frames. More generally, the extraction process can be done by summing any of the frames from the image sequence, whether consecutive or not, assuming of course that the distributed message bits 28 have all been selected from the same N message bits (i.e., the total message payload has not changed). For example, for extraction, every fifth frame could be sampled, every tenth frame, or even at a random sampling interval. This larger temporal sampling interval is motivated by the observation that image content in motion pictures is often highly correlated between consecutive frames. Sampling the image sequence at larger time intervals can diminish the effect of image content, which acts as a noise term during the extraction process as described in Eq. 2. This approach can be extended even further by using the image content itself to control which frames are summed during the extraction process. That is, we may use only those frames that have minimal image content or frames that produce a minimal noise term when the content interacts with the carrier. As another alternative, we may wish to only use the intracoded frames (I-frames) in a compressed sequence (such as an MPEG-2 encoded sequence), because the I-frames have the highest fidelity relative to the P and B-frames, and hence the watermark will also be reproduced with the highest fidelity in these I-frames. When using a temporal subset of frames, a possible tradeoff is that it cannot be assured of recovering the full set of message bits 28 with the minimum number of frames, as would generally be the case for sampling consecutive frames. To minimize the number of frames that are needed for extraction when using a larger frame sampling interval, it may be advantageous to monitor the signal strength at each of the bit locations in the extracted message array, and include those frames that improve the balance of the signal strengths across all bit locations.

Tiling

Although we have described the present invention in terms of a watermark pattern that is the same size as the original frame, the same concepts can be used when the watermark is arranged as tiles 32 as shown in FIG. 4. While the same pattern could be used for all tiles within a given image frame, one approach to minimizing the watermark visibility while improving extraction performance is to use a different watermark patterns within the watermark tiling structure for the frame. The assignment of message bits 28 (and hence the watermark pattern) can be changed for every image tile 32 within image frame 18 or at some interval spanning multiple image tiles 32 within image frame 18. To provide a time-varying look, it is only necessary to change the bit assignment (and hence the watermark pattern) for a given tile from frame to frame and/or shuffle the tile location of the various watermark patterns from frame to frame. During the extraction process, the watermarked image tiles can be summed both within a given frame and also across multiple frames. The resulting summed watermarked image tile is then used to extract the complete N-bit codeword. An interesting observation is that if the various bit assignments for the image tiles within a single frame include at least one occurrence of each of the N message bits 28, it is possible that the entire message payload could be extracted from only one frame. It must be noted that this is not generally the case when time-varying watermarks are used.

Resistance to Attack

The present invention also provides for improved robustness to intentional attacks that try to detect and remove, or at least obscure, the watermark pattern. When completely static watermark patterns are used (i.e., the same pattern is used for every frame), it can be possible to compute the watermark pattern by averaging many frames. The averaging process causes a static watermark to reinforce itself (because it is the same in every frame), while the image content changes from frame to frame and eventually averages out to be a very small signal. An attacker could then subtract the computed watermark pattern from every frame, thus removing the static watermark information. With the temporally distributed watermark of the present invention, on the other hand, the averaging of frames would provide only an estimate of the watermark pattern that corresponds to the entire message payload. If an attacker subtracts this computed pattern from the temporally distributed watermarks (in which each frame or tile has a different set of message bit 28 assignments), the attacker might remove some of the message bit information, but could effectively introduce an inverse pattern of the remaining bits, thereby defeating the attempt at watermark removal or concealment. Further, the watermark message itself can be designed in such a way that it is robust to polarity changes, so this attack would not remove the watermark information, but would only change its representation.

Another type of intentional attack can be applied to conventional types of time-varying watermarks as described by Rhoads in U.S. Pat. No. 6,449,379. With these watermarks, the carrier or the total message payload may be changed from frame to frame. An attacker can compute an estimate for a given watermarked frame by using the average of temporally adjacent frames, and can then replace the watermarked frame with the estimated frame. The averaging of the adjacent frames reduces any watermark information that is present (because the watermarks are largely unrelated in adjacent frames) and hence the replaced frame may no longer have a detectable watermark. In contrast, the present method is robust where adjacent frames are averaged because the temporally distributed message bits combine in the averaged frame according to the message or shift template design. With the present invention, this type of attack effectively performs the first step of the extraction process as outlined in FIG. 7, and thus does not damage the watermark information in any way.

The preceding discussion uses the concepts of image frames 18 and tiles 32 within an image frames 18. These concepts are easily used with respect to digital motion imaging systems such as digital cinema (DCinema). However, it is important to note that the same concepts can be adapted to a traditional film-based system, where the watermark patterns are exposed during film manufacturing or during the printing of the final image content. Film-based watermarking systems are disclosed, for example, in a commonly assigned U.S. patent application entitled WATERMARKING METHOD FOR MOTION PICTURE IMAGE SEQUENCE by Jones et al. Ser. No. 10/778,528, filed Feb. 13, 2004. Systems such as those described with reference to this copending application may be directly combined with the present invention.

The method of the present invention offers clear advantages over other types of motion picture image watermarking schemes. When using partial message arrays 34 with positional significance to message bits 28, no temporal synchronization is required. Any sampling of image frames 18 or image tiles 32 having a sufficient number of image frames 18 or tiles 32 can be suitably encoded and decoded. Because only a single carrier signal 12 is needed, watermark extraction can be performed efficiently.

The invention has been described in detail with particular reference to certain preferred embodiments thereof, but it will be understood that variations and modifications can be effected within the spirit and scope of the invention. For example, various arrangements of different carrier signals 12 and messages 10 could be employed, with a resulting increase in encoding and decoding complexity. The method of the present invention can also be combined with other more complex methods including public/private key encryption of message bits 28. Watermark embedding may be applied to a monochrome or color image. For color images, the temporal watermarking scheme of the present invention could be applied to one or more color channels that comprise a digital image frame or to one or more color sensitive layers that comprise a motion picture film. The method of the present invention is advantaged for watermark application to scene content for successive frames of digital motion picture data, such as MPEG data for example, or to scene content for successive frames of motion picture film or other sensitized medium for image recording. In addition, the method of the present invention could alternately be applied to a single tiled image frame, as is shown in FIG. 4, using a series of image tiles 32, wherein different image tiles 32 in the series contain different portions of the complete N-bit watermark.

Thus, what is provided is a method for embedding a watermark pattern representing message bits in a digital image sequence that uses the temporal dimension, but without requiring temporal synchronization for extraction of the message bits, that has improved robustness, and that is relatively imperceptible to a viewer.

### PARTS LIST

10 Message bits
12 Carrier signal
14 Shifted carrier signal
16 Watermark pattern
18 Original image
20 Watermarked image
22 Shift template
24 Message bit locations in shift template (delta function)
24a Message bit locations in shift template (delta function)
24b Message bit locations in shift template (delta function)
24c Message bit locations in shift template (delta function)
24d Message bit locations in shift template (delta function)
24e Message bit locations in shift template (delta function)
26 Message array
28 Message bits in message array
28a Message bits in message array
28b Message bits in message array
28c Message bits in message array
28d Message bits in message array
28e Message bits in message array
30 Extracted message array
32 Image tile
34 Partial message array
34a Partial message array
34b Partial message array
34c Partial message array
34d Partial message array
34e Partial message array
36 Set of watermark patterns
38 Summed image frames

1. A method for temporally distributing a watermark signal into a sequence comprising a plurality of original image frames, wherein the watermark signal represents an N-bit codeword and wherein N is greater than or equal to two, the method comprising, for each original image frame in the sequence, comprising the steps of:
(a) selecting a non-empty subset of bits from the N-bit codeword;
(b) generating a watermark pattern according to the non-empty subset of bits; and
(c) combining said watermark pattern with said original image frame to produce a watermarked image frame; whereby, over the sequence comprising said plurality of original image frames, all bits in the N-bit codeword are selected in at least one of said non-empty subsets of bits.

2. The method according to claim 1, wherein each bit in the N-bit codeword is assigned a unique spatial location within a two-dimensional array, and wherein the step of generating the watermark pattern further comprises:
(a) cyclically shifting a carrier to a spatial location corresponding to each bit in said subset to produce a cyclically shifted carrier corresponding to each bit in said subset;
(b) adjusting the polarity of each cyclically shifted carrier according to the data value of the corresponding selected bit; and
(c) combining the adjusted cyclically shifted carriers to produce the watermark pattern.

3. A method according to claim 1 comprising the further step of extracting an N-bit codeword from watermarked image frames, the extraction method comprising the steps of:
(a) summing a sequence of watermarked images frames that contains at least one occurrence of each bit in the N-bit codeword to obtain a summed watermarked image frame; and
(b) extracting said N-bit codeword from the summed watermarked image frame.

4. A method according to claim 2 comprising the further step of extracting an N-bit codeword from watermarked image frames, the extraction method comprising the steps of:
(a) summing a sequence of watermarked images frames that contains at least one occurrence of each bit in the N-bit codeword to obtain a summed watermarked image frame; and
(b) correlating said carrier with said summed watermarked image frame to extract said N-bit codeword.

5. A method for applying a watermark pattern according to claim 1 wherein the step of combining said watermark pattern with said original image frame comprises the step of exposing said watermark pattern onto a photosensitive medium.

6. A method for applying a watermark pattern according to claim 1 wherein the step of combining said watermark pattern with said original image frame comprises the step of tiling a plurality of copies of said watermark pattern over said original image frame.

7. A method for applying a watermark pattern according to claim 1 wherein the step of combining the watermark pattern is performed in at least one color of an original image frame comprising multiple colors.

8. A method according to claim 1 wherein the step of selecting a subset of bits for each original image frame comprises the step of selecting a subset having the same number of bits for each original image frame.

9. A method according to claim 1 wherein the step of combining comprises the step of adding the watermark pattern.

10. A method according to claim 1 wherein the sequence of original image frames comprises consecutive original image frames.

11. A method according to claim 1 wherein the sequence of original image frames is other than consecutive.

12. A method according to claim 1 wherein the step of generating a watermark pattern comprises the step of spatially shifting a carrier signal according to the selected subset of bits.

13. A method for temporally distributing a watermark signal into a sequence comprising a plurality of original image frames, wherein the watermark signal represents an N-bit codeword and wherein N is greater than or equal to two, the method comprising the steps of:
(a) producing a set of M watermark patterns, wherein each watermark pattern corresponds to a subset of bits from the N-bit codeword and all bits of the N-bit codeword are represented at least once in the set of M watermark patterns;
(b) selecting a watermark pattern for an original image frame from the set of M watermark patterns;
(c) combining said watermark pattern with said original image frame to produce a watermarked image frame; and
(d) repeating steps (b) and (c) for each original image frame in said sequence to produce a sequence of watermarked image frames.

14. The method according to claim 13, wherein each bit in the N-bit codeword is assigned a unique spatial location within a two-dimensional array, and wherein the step of producing each member of the set of M watermark patterns further comprises:
(a) cyclically shifting a carrier to a spatial location corresponding to each bit in the subset to produce a cyclically shifted carrier corresponding to each bit in said subset;
(b) adjusting the polarity of each cyclically shifted carrier according to the data value of corresponding bits in the subset; and
(c) combining the adjusted cyclically shifted carriers to produce the watermark pattern.

15. A method according to claim 13 wherein the amplitude distribution of each member of the set of M watermark patterns is visually equivalent.

16. A method according to claim 13 wherein each subset of bits for the members of the set of M watermark patterns has the same number of bits.

17. A method according to claim 13 wherein the patterns for consecutive original frames are selected to have maximum visual differences.

18. A method according to claim 13 comprising the further step of extracting an N-bit codeword from watermarked image frames, the extraction method comprising the steps of:
(a) summing a sequence of watermarked images frames that contains at least one occurrence of each bit in the N-bit codeword to obtain a summed watermarked image frame; and
(b) extracting said N-bit codeword from the summed watermarked image frame.

19. A method according to claim 14 comprising the further step of extracting an N-bit codeword from watermarked image frames, the extraction method comprising the steps of:
(a) summing a sequence of watermarked images frames that contains at least one occurrence of each bit in the N-bit codeword to obtain a summed watermarked image frame; and
(b) correlating said carrier with said summed watermarked image frame to extract said N-bit codeword.

20. A method for distributing a watermark signal within an original image frame, wherein the watermark signal represents an N-bit codeword and wherein N is greater than or equal to two, the method comprising:
(a) producing a set of M watermark patterns, wherein each watermark pattern corresponds to a subset of bits from the N-bit codeword and all bits of the N-bit codeword are represented at least once in the set of M watermark patterns;
(b) selecting a watermark pattern from the set of M watermark patterns;
(c) combining said watermark pattern with a portion of the original image frame to produce a watermarked image tile; and
(d) repeating steps (b) and (c), thereby forming an array of watermarked image tiles combined with said original image frame to produce a watermarked image frame.

21. A method according to claim 20 wherein forming an array of watermarked image tiles comprises the step of combining each member of the set of M watermark patterns at least once.

22. A method according to claim 20 wherein the amplitude distribution of each member of the set of M watermark patterns is visually equivalent.

23. A method according to claim 20 wherein each subset of bits for the members of the set of M watermark patterns has the same number of bits.

24. A method according to claim 20 comprising the further step of extracting an N-bit codeword from the watermarked image frame, the extraction method comprising the steps of:
(a) summing an array of watermarked image tiles that contains at least one occurrence of each bit in the N-bit codeword to obtain a summed watermarked image tile; and
(b) extracting said N-bit codeword from the summed watermarked image tile.

25. A method for temporally distributing a watermark signal into a sequence comprising a plurality of original image frames, wherein the watermark signal represents an N-bit codeword and wherein N is greater than or equal to two, the method comprising the steps of:
(a) producing a set of M watermark patterns, wherein each watermark pattern corresponds to a subset of bits from the N-bit codeword and all bits of the N-bit codeword are represented at least once in the set of M watermark patterns;
(b) selecting a watermark pattern from the set of M watermark patterns;
(c) combining said watermark pattern with a portion of an original image frame to produce a watermarked image tile;
(d) repeating steps (b) and (c), thereby forming an array of watermarked image tiles combined with said original image frame to produce a watermarked image frame; and
(e) repeating steps (b), (c), and (d) for each original image frame in said sequence to produce a sequence of watermarked image frames.

26. An image recording medium having, recorded thereon, a sequence of image frames,
wherein each image frame in the sequence comprises original scene content encoded with a watermark pattern, wherein each watermark pattern represents fewer than N bits of an N-bit codeword, wherein N is greater than or equal to two;
such that a grouping of a plurality of the watermark patterns encoded within the sequence of image frames represents the full N-bit codeword.

27. An image recording medium according to claim 26 wherein the image recording medium is a motion picture print film.

28. A image recording medium according to claim 26 wherein the image recording medium is a digital data storage medium.

29. An image recording medium having, recorded thereon, an image comprising scene content encoded with a set of tiled watermark patterns, wherein each tiled watermark pattern of the set represents fewer than N bits of an N-bit codeword, wherein N is greater than or equal to two, such that a combination of the set of tiled watermark patterns represents the full N-bit codeword.

30. Digital image data having, encoded therein, a sequence of image frames,
wherein each image frame in the sequence comprises original scene content encoded with a watermark pattern, wherein each watermark pattern represents fewer than N bits of an N-bit codeword, wherein N is greater than or equal to two;
such that a grouping of a plurality of the watermark patterns encoded within the sequence of image frames represents the full N-bit codeword.
